(19) United States
(12) Patent Application Publication
(10) Pub. No.: US 2021/0104199 A1
(43) Pub. Date: Apr. 8, 2021

(54) METHOD AND DEVICE FOR DISPLAYING A MULTI-COLOURED IMAGE ON A BACKLIT DISPLAY WITHOUT COMPONENTS THAT REDUCE THE RESOLUTION OF A DISPLAY

(71) Applicant: Michael BUCZEK, Bexbach (DE)

(72) Inventor: Michael BUCZEK, Bexbach (DE)

(21) Appl. No.: 16/607,970

(22) PCT Filed: Jan. 6, 2018
(86) PCT No.: PCT/DE2018/000002

§ 371 Date: Oct. 24, 2019

(30) Foreign Application Priority Data
May 10, 2017 (DE) 10 2017 004 500.3

(51) Int. Cl. G09G 3/34; G09G 5/02

(52) U.S. Cl. CPC G09G 3/3413; G09G 2310/0235; G09G 5/026

(57) ABSTRACT

A method and a device which are able to display a multi-colored image on a backlit display, without using components that reduce the resolution of a display. A display method for displaying a multi-colored image on a backlit display, without components that reduce the resolution of a display, includes a temporally sequential controlling of individually controllable colors of an at least two-colored backlight of a display, and an associating of image element values to colors of an at least two-colored backlight of a display. A display device also includes units which are designed to carry out the display method described above.

The present invention relates to a method and to a device for displaying a multicolored image on a backlit display without components that reduce the resolution of a display.

In the prior art, backlit multicolored LCDs (liquid-crystal displays) are used in order to display multicolored images. Such backlit multicolored displays comprise backlighting, pixels and color filters.

The backlighting of a multicolored display may, for example, be direct or indirect (edge-lit) backlighting which comprise individual LEDs (light-emitting diodes) or LED groups that can be driven independently of one another. The color of the backlighting is monochromatic.

The pixels of a multicolored display transmit light. The transmission of light is controlled in the form of pixel values, or gray values (GW).

The color filters of a multicolored display may, for example, be passive red-green-blue color filters, which are respectively arranged behind a pixel. The unit consisting of three adjacent pixels with a red, green and blue color filter forms a red-green-blue pixel.

A color, or a color value, in the red-green-blue color space is generated on the basis of the controllable light transmission of red-green-blue pixels.

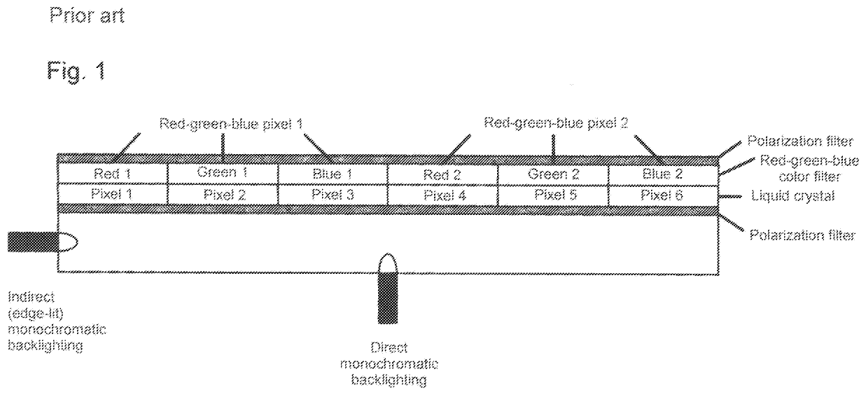

FIG. 1 shows a schematic structure of direct and indirect monochromatic backlighting of a multicolored display in the prior art.

In general, a backlit multicolored display comprises a passive red-green-blue color filter matrix. A passive red-green-blue color filter matrix reduces the resolution of a display by a factor of three.

The object of the present invention is to provide a method and a device which are capable of displaying a multicolored image on a backlit display without using components that reduce the resolution of a display.

This object is achieved by the measures specified in the independent claims.

The dependent claims relate to further advantageous configurations of the present invention.

A display method for displaying a multicolored image on a backlit display without components that reduce the resolution of a display comprises chronologically sequential driving of individually drivable colors of at least two-colored backlighting of a display and allocation of pixel values to colors of at least two-colored backlighting of a display.

According to one refinement, the individually drivable colors of at least two-colored backlighting of a display are driven chronologically in parallel.

Furthermore, a display device comprises instruments that are configured for carrying out the display method described above, or the refinement thereof.

The present invention will be explained in more detail below with the aid of an exemplary embodiment with reference to the appended drawing.

In the drawing:

FIG. 1 shows a schematic structure of direct and indirect monochromatic backlighting of a multicolored display in the prior art.

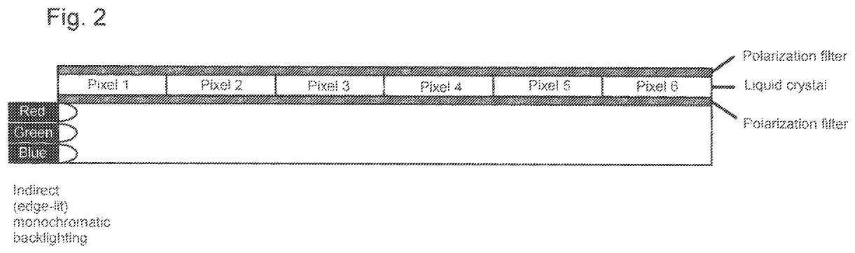

FIG. 2 shows a schematic structure of indirect three-colored red-green-blue backlighting of a display without components that reduce the resolution of a display, according to a first exemplary embodiment of the present invention.

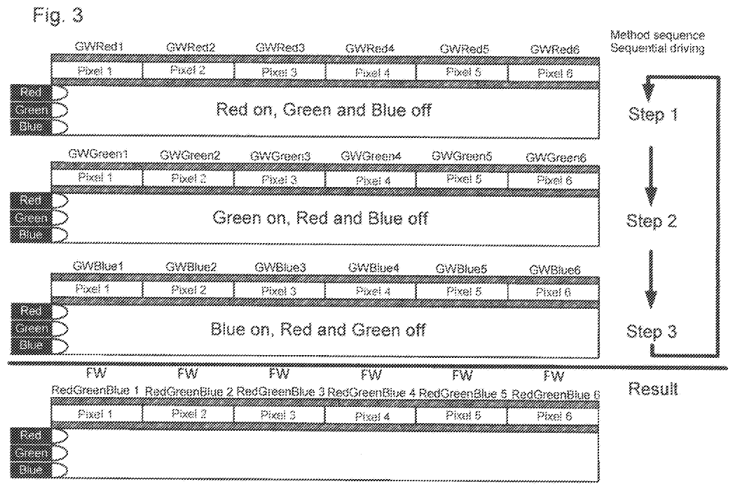

FIG. 3 shows a method sequence of chronologically sequential driving of individually drivable colors of three-colored red-green-blue backlighting of a display and allocation of pixel values to colors of three-colored red-green-blue backlighting of a display with the aid of the schematic structure in FIG. 2 according to the first exemplary embodiment of the present invention.

The description of a first exemplary embodiment of the present invention is given below.

FIG. 2 shows a schematic structure of indirect three-colored red-green-blue backlighting of a display without components that reduce the resolution of a display, according to a first exemplary embodiment of the present invention.

In FIG. 2, “red” denotes the red-colored backlighting, “green” denotes the green-colored backlighting and “blue” denotes the blue-colored backlighting.

FIG. 3 shows a method sequence of chronologically sequential driving of individually drivable colors of three-colored red-green-blue backlighting of a display and allocation of pixel values to colors of three-colored red-green-blue backlighting of a display with the aid of the schematic structure in FIG. 2 according to the first exemplary embodiment of the present invention.

In order to control individually drivable colors of three-colored red-green-blue backlighting of a display, PWM or pulse width modulation signals may be used, for example, which control the sequential phases of chronologically sequential driving of three-colored red-green-blue backlighting of a display.

The light transmission of the pixels of a display is allocated by means of the pixel values or the gray values (GW) GW_{red}, GW_{green}, GW_{blue} to the colors of three-colored red-green-blue backlighting of a display.

In this example, the method sequence of chronologically sequential driving of individually drivable colors of three-colored red-green-blue backlighting of a display and allocation of pixel values to colors of three-colored red-green-blue backlighting of a display is based on three steps.

In a step 1, the driving of the red-colored backlighting of a display (“red on”) is carried out, the green- and blue-colored backlighting being switched off (“green and blue off”). The light transmission of the pixels of a display is adjusted by means of the gray values GW_{red}.

The method sequence then continues to step 2.

In a step 2, the driving of the green-colored backlighting of a display (“green on”) is carried out, the red- and blue-colored backlighting being switched off (“red and blue off”). The light transmission of the pixels of a display is adjusted by means of the gray values GW_{green}.

The method sequence then continues to step 3.

In a step 3, the driving of the blue-colored backlighting of a display (“blue on”) is carried out, the red- and green-colored backlighting being switched off (“red and green off”). The light transmission of the pixels of a display is adjusted by means of the gray values GW_{blue}.

After step 3, the method sequence returns to step 1.

The order of the method sequence is freely selectable.

The color values (CW) of the pixels of a display are defined according to a method sequence by the red-green-blue gray values in the red-green-blue color space:

CW_{RedGreenBlue}={GW_{red},GW_{green},GW_{blue}}

In summary, a multicolored image may be displayed on a backlit display without using components that reduce the resolution of a display.

The method and the device may be implemented with standard components.

The description of a second exemplary embodiment of the present invention is given below.

The second exemplary embodiment of the present invention is identical to the first exemplary embodiment of the present invention apart from the modifications described below, so that the comments made regarding the first exemplary embodiment of the present invention likewise apply for the second exemplary embodiment of the present invention.

A further advantageous refinement of the present invention is specified in patent claim 2. The individually drivable colors of three-colored red-green-blue backlighting of a display are driven chronologically in parallel. For example, the colors of three-colored red-green-blue backlighting of a display in the steps of a method sequence may be mixed colors in the red-green-blue color space. The mixed colors may, for example, be adjusted image-dependently.

The description of a third exemplary embodiment of the present invention is given below.

The third exemplary embodiment of the present invention is identical to the second exemplary embodiment of the present invention apart from the modifications described below, so that the comments made regarding the second exemplary embodiment of the present invention likewise apply for the third exemplary embodiment of the present invention.

A further advantageous refinement of the present invention is that steps of a method sequence are omitted. In the case of a two-colored image, for example, it is possible to carry out only two steps of chronologically sequential driving of three-colored red-green-blue backlighting of a display. This type of driving increases the contrast of the image to be represented.

Although the present invention has been described above with the aid of exemplary embodiments, it is to be understood that various refinements and modifications may be carried out without departing from the scope of the present invention as this scope is defined in the appended claims.

In relation to further features and advantages of the present invention, reference is explicitly made to the disclosure of the drawing.

1-3. (canceled)

4. A method for displaying a multicolored image on a backlit display without components that reduce resolution of the display, the method comprising the steps of:
(a) chronologically sequential, chronologically parallel and chronologically adjustable driving of individually drivable primary colors of at least two-colored backlighting of the display; and
(b) allocating of pixel values to colors of the at least two-colored backlighting of the display.

5. The method according to claim 4, wherein individually drivable colors of the at least two-colored backlighting of the display are driven chronologically in parallel.

6. A device for displaying a multicolored image on a backlit display without components that reduce resolution of the display, comprising:
(a) an arrangement of individually drivable colors of at least two-colored backlighting of the display;
(b) a driver for driving the individually drivable colors of the at least two-colored backlighting of the display; and
(c) a display unit without components that reduce resolution of the display.
